(19) United States
(12) Patent Application Publication
(10) Pub. No.: US 2026/0291212 A1
(43) Pub. Date: Sep. 24, 2026

(54) DIRECT CURRENT CONVERSION DEVICE AND SYSTEM

(71) Applicant: CRRC ZHUZHOU ELECTRIC LOCOMOTIVE RESEARCH INSTITUTE CO., LTD., Zhuzhou, Hunan (CN)

(72) Inventors: Xiulin CHEN, Zhuzhou, Hunan (CN); Sanhu WANG, Zhuzhou, Hunan (CN); Chao HUANG, Zhuzhou, Hunan (CN); Mingyuan YANG, Zhuzhou, Hunan (CN); Haoping LIU, Zhuzhou, Hunan (CN); Wanyong RAO, Zhuzhou, Hunan (CN); Bin WU, Zhuzhou, Hunan (CN); Hongze DAI, Zhuzhou, Hunan (CN); Zhifeng TANG, Zhuzhou, Hunan (CN); Shufang TANG, Zhuzhou, Hunan (CN); Bin ZHOU, Zhuzhou, Hunan (CN)

(73) Assignee: CRRC ZHUZHOU ELECTRIC LOCOMOTIVE RESEARCH INSTITUTE CO., LTD., Zhuzhou, Hunan (CN)

(21) Appl. No.: 19/479,756

(22) PCT Filed: Sep. 5, 2024
(86) PCT No.: PCT/CN2024/117118

§ 371 Date: Oct. 29, 2025

(30) Foreign Application Priority Data
Nov. 7, 2023 (CN) 202311473462.0

(51) Int. Cl. H02H 7/12; H02J 1/16; H02J 13/13; H02M 1/00; H02M 3/00

(52) U.S. Cl. CPC H02H 7/1213; H02J 1/16; H02J 13/1321; H02M 1/0074; H02M 1/0077; H02M 3/003

(57) ABSTRACT

A direct current conversion device and system, relating to the technical field of high voltage direct current transmission. The direct current conversion device comprises a normally-on solid-state circuit breaker, a control panel and a plurality of power modules; a direct current is input into the direct current conversion device by means of the normally-on solid-state circuit breaker; the input ends of the power modules are connected in series, and the output ends of the power modules are connected in parallel; each power module is used for carrying out power conversion on the input direct current and supplying power to the control panel; and the control panel is used for receiving voltage signals and/or current signals fed back by the power modules and controlling the power modules, controlling the normally-on solid-state circuit breaker and performing signal interaction with control panels in other direct current conversion devices to enable the direct current conversion devices to be uniform in current. The direct current conversion device can realize black start, has low costs, and is stable and reliable.

The present application claims the priority to Chinese Patent Application No. 202311473462.0, titled “DIRECT CURRENT CONVERSION DEVICE AND SYSTEM”, filed on Nov. 7, 2023 with the China National Intellectual Property Administration, which is incorporated herein by reference in its entirety.

### FIELD

The present disclosure relates to the technical field of high-voltage direct-current power supply, and in particular to a direct-current conversion device and a direct-current conversion system.

### BACKGROUND

Long-distance power supply is widely applied in various environments. Cost-effectiveness and reliability are critical metrics for long-distance power supply. To minimize line losses, high-voltage power supply is typically employed. At a load end of long-distance power supply, a high voltage is converted to a low voltage suitable for the load end. Long-distance power supply may be alternating-current power supply or direct-current power supply. High-voltage direct-current power supply features low cable costs and stable cable impedance and therefore is more widely adopted. The black start capability of a conversion device further reduces cable costs, and thus is an essential function for long-distance power supply. The conversion device is configured with functions such as fault protection and removal, power redundancy and remote data interaction, in order to enhance power supply stability at the load end, thus maximizing power supply reliability. Therefore, how to provide a direct-current conversion device configured with the above functions has become an urgent technical issue to be addressed by those skilled in the art.

An objective of the present disclosure is to provide a direct-current conversion device, to achieve black start, low cost, high stability and reliability. Another objective of the present disclosure is to provide a direct-current conversion system, which also has the above technical effects.

To address the above technical issue, a direct-current conversion device is provided in the present disclosure. The direct-current conversion device includes a normally-on solid-state circuit breaker, a control board and multiple power modules.

A direct-current power is input to the direct-current conversion device via the normally-on solid-state circuit breaker. Input terminals of the multiple power modules are connected in series, and output terminals of the multiple power modules are connected in parallel.

Each of the multiple power modules is configured to perform power conversion on the input direct-current power, and supply power to the control board.

The control board is configured to receive at least one of voltage signals and current signals fed back by the multiple power modules, control the multiple power modules, control the normally-on solid-state circuit breaker, and perform signal interaction with a control board in other direct-current conversion device, where current sharing is achieved between the direct-current conversion device and other direct-current conversion device.

In an embodiment, each of the multiple power modules includes a main power conversion circuit, an auxiliary power supply and a micro power module.

The main power conversion circuit is configured to perform power conversion on the input direct-current power.

The auxiliary power supply is configured to supply power to the control board via the micro power module.

In an embodiment, each of the multiple power modules includes a voltage dividing capacitor. The voltage dividing capacitor is configured to perform voltage division on the input direct-current power.

In an embodiment, the multiple power modules further include respective decoupling diodes.

An anode of each of the respective decoupling diodes is connected to an output terminal of the power module; and cathodes of the respective decoupling diodes in the multiple power modules are connected to each other.

In an embodiment, the control board includes:
a main control chip, configured to perform signal interaction with the normally-on solid-state circuit breaker, the multiple power modules, and a control board in other direct-current conversion device; and
multiple diodes are in a one-to-one correspondence with the multiple power modules, where the multiple diodes are connected in series with a power input terminal of the control board, and direct-current powers output from the micro power modules are input to the control board via the multiple diode, respectively.

In an embodiment, auxiliary power supplies for the control board and auxiliary power supplies for a control board in other direct-current conversion device are connected to an auxiliary bus.

In an embodiment, the control board performs signal interaction with a control board in other direct-current conversion device via a CAN bus.

In an embodiment, the control board is further configured to receive a system instruction and upload data.

In an embodiment, the multiple power modules in the direct-current conversion device are arranged in two layers. The power module in an upper layer is arranged on a cover plate, and the power module in a lower layer is arranged on a bottom of a housing. The control board is arranged in an intermediate layer.

In an embodiment, the power module in the upper layer is fixed to the cover plate via bolts, and the power module in the lower layer is fixed to the housing via bolts.

To address the above technical issue, a direct-current conversion system is further provided in the present disclosure. The direct-current conversion system includes multiple direct-current conversion devices as described above. Output terminals of the multiple direct-current conversion devices are connected in parallel.

In an embodiment, the output terminals of the multiple direct-current conversion devices are connected in series with respective fuses to form branches, and the branches are connected in parallel.

The direct-current conversion device in the present disclosure includes a normally-on solid-state circuit breaker, a control board and multiple power modules. A direct-current power is input to the direct-current conversion device via the normally-on solid-state circuit breaker. Input terminals of the power modules are connected in series, and output terminals of the power modules are connected in parallel. Each of the power modules is configured to perform power conversion on the input direct-current power, and supply power to the control board. The control board is configured to receive at least one of voltage signals and current signals fed back by the power modules, control the power modules, control the normally-on solid-state circuit breaker, and perform signal interaction with a control board in other direct-current conversion device, where current sharing is achieved between the direct-current conversion device and other direct-current conversion device.

It can be seen that the direct-current conversion device in the present disclosure is provided with the normally-on solid-state circuit breaker. A high-voltage direct-current power is transmitted to the power modules before the control board is started. The power modules perform power conversion on the input high-voltage direct-current power to obtain a low-voltage direct-current power and supply power to the control board, thereby achieving black start. Thus, a pre-charging circuit is no longer required, effectively reducing the cost and design difficulty. Furthermore, the power modules operate in redundancy mode to supply power to the control board, improving the reliability of the control board. The structure in which input terminals of the power modules are connected in series and output terminals of the power modules are connected in parallel inherently features voltage sharing and current sharing, and implements voltage sharing and current sharing in conjunction with software control. Thus, power supply stability is improved. The control board may turn off the normally-on solid-state circuit breaker to remove a fault, achieving fault protection and removal.

The direct-current conversion system in the present disclosure also has the above technical effects.

### BRIEF DESCRIPTION OF THE DRAWINGS

To more clearly describe the technical solutions in the embodiments of the present disclosure, drawings to be used in the description of the embodiments of the present disclosure or in the conventional technology are briefly described hereinafter. It is apparent that the drawings described below are merely used for describing the embodiments of the present disclosure and those skilled in the art may obtain other drawings based on the drawings without any creative effort.

FIG. 1 is a schematic diagram of a direct-current conversion device according to an embodiment of the present disclosure;

FIG. 2 is a schematic diagram of an auxiliary power supply according to an embodiment of the present disclosure;

FIG. 3 is a schematic diagram of power supply according to an embodiment of the present disclosure; and

FIG. 4 is a schematic diagram showing heat dissipation of a power module according to an embodiment of the present disclosure;

FIG. 5 is a schematic diagram of a direct-current conversion system according to an embodiment of the present disclosure; and

FIG. 6 is a schematic diagram of a direct-current conversion system according to another embodiment of the present disclosure.

### DETAILED DESCRIPTION

A direct-current conversion device is provided in the present disclosure, to achieve black start, low cost, high stability and reliability. A direct-current conversion system is further provided in the present disclosure, which also has the above technical effects.

To make the objectives, technical solutions and advantages of the embodiments of the present disclosure clearer, the technical solutions in the embodiments of the present disclosure are described clearly and completely hereinafter with reference to the drawings in the embodiments of the present disclosure. Apparently, the described embodiments are a part of embodiments of the present disclosure, rather than all of embodiments. Based on the embodiments of the present disclosure, all other embodiments obtained by those skilled in the art without any creative effort fall within the protection scope of the present disclosure.

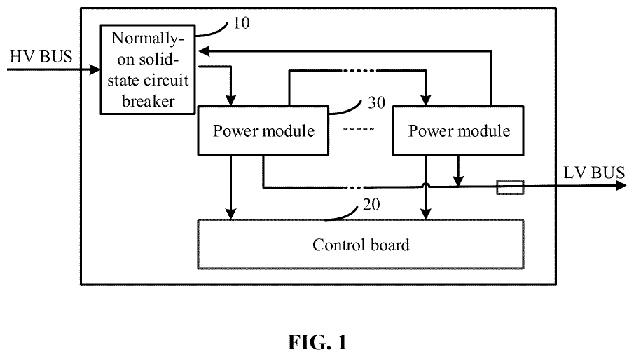

Reference is made to FIG. 1, which is a schematic diagram of a direct-current conversion device. Referring to FIG. 1, the direct-current conversion device includes a normally-on solid-state circuit breaker 10, a control board 20, and multiple power modules 30.

A direct-current power is input to the direct-current conversion device via the normally-on solid-state circuit breaker 10. Input terminals of the power modules 30 are connected in series, and output terminals of the power modules 30 are connected in parallel.

Each of the power modules 30 is configured to perform power conversion on the input direct-current power and supply power to the control board 20.

The control board 20 is configured to receive at least one of voltage signals and current signals fed back by the power modules 30, control the power modules 30, control the normally-on solid-state circuit breaker 10, and perform signal interaction with a control board 20 in other direct-current conversion device, achieving current sharing between the direct-current conversion device and other direct-current conversion device.

The direct-current conversion device in the embodiment generally includes a normally-on solid-state circuit breaker 10, a control board 20, and multiple power modules 30. A high-voltage bus (HV BUS) is connected to an input terminal of the direct-current conversion device, and a high-voltage direct-current power is input to the power modules 30 via the normally-on solid-state circuit breaker 10.

The input terminals of the power modules 30 are connected in series, and the output terminals of the power modules 30 are connected in parallel. In an aspect, each of the power modules 30 performs power conversion on the input high-voltage direct-current power to output a low-voltage direct-current power to a low-voltage bus (LV BUS) for power supply. The low-voltage direct-current power is supplied to a load arranged outside the direct-current conversion device. In another aspect, the power modules 30 perform auxiliary power supply on the control board 20 in the direct-current conversion device. In a direct-current conversion device, a quantity n of the power modules 30 is determined based on a maximum value Vinmax of the input high-voltage direct-current power and a maximum operating voltage Vnmax of each of the power modules 30. n, Vinmax and Vnmax satisfy n>Vinmax/Vnmax.

In some embodiments, each of the power modules 30 includes a main power conversion circuit, an auxiliary power supply and a micro power module.

The main power conversion circuit is configured to perform power conversion on the input direct-current power.

The auxiliary power supply is configured to supply power to the control board 20 via the micro power module.

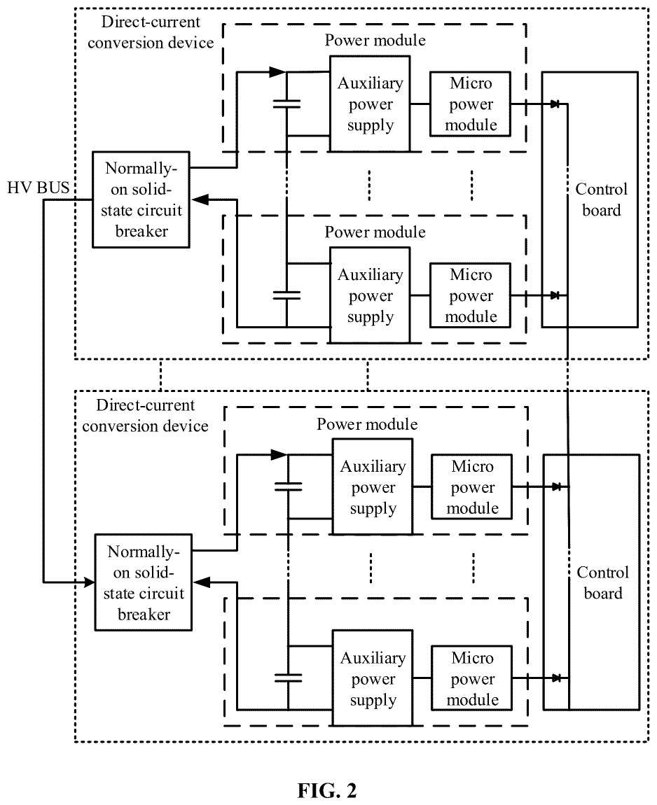

The main power conversion circuit is configured to perform power conversion on an input high-voltage direct-current power to obtain a low-voltage direct-current power for power supply. The main power conversion circuit may include a rectifier circuit, a transformer, a filter and the like. The auxiliary power supply and the micro power module are configured to perform auxiliary power supply. Each of the power modules 30 is provided with an independent auxiliary power supply. Referring to FIG. 2, an input high-voltage direct-current power is regulated to a stable voltage level via the auxiliary power supply, and then the stable voltage level is supplied to the control board 20 via the micro power module. The micro power module is configured to implement high isolation and low-power conversion. The auxiliary power supply is further configured to supply power to a driver and a control circuit for power transistors on a primary side of the transformer in the power module 30. Through high-isolation driving and high-isolation sampling, real-time control and monitoring on the main power conversion circuit, active voltage sharing on the primary side and current sharing between the power modules 30 can be achieved.

In some embodiments, each of the power modules 30 further includes a voltage dividing capacitor. The voltage dividing capacitor is configured to perform voltage division on the input direct-current power.

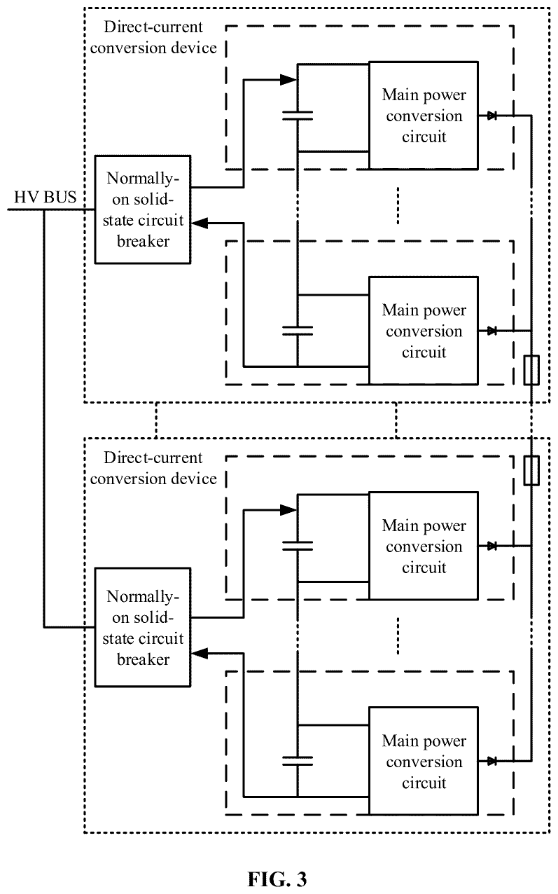

Referring to FIG. 3, a voltage of the input high-voltage direct-current power in the embodiment is divided by the voltage dividing capacitor, and then is subjected to power conversion to obtain a low-voltage direct-current power. The voltage of the input high-voltage direct-current power is divided by the voltage dividing capacitor and is regulated to a stable voltage level via the auxiliary power supply, and then the stable voltage level is supplied to the control board 20 via the micro power module. The auxiliary power supply may be implemented by a low-voltage auxiliary power supply. Thus, no high-voltage auxiliary power supply is required, simplifying design of the auxiliary power supply.

In some embodiments, each of the power modules 30 further includes a decoupling diode.

An anode of the decoupling diode is connected to an output terminal of the power module 30, and cathodes of decoupling diodes in the power modules 30 are connected to each other.

Referring to FIG. 3, each of the power modules 30 is provided with a decoupling diode. An anode of the decoupling diode is connected to the output terminal of the power module 30, and cathodes of the decoupling diodes in the power modules 30 in a same direct-current conversion device are connected to each other. That is, the output terminal of each of the power modules 30 is connected in series with a decoupling diode to form a branch and all the branches are connected in parallel, to prevent current backflow.

The control board 20 performs signal interaction with the normally-on solid-state circuit breaker 10 and the power modules 30 in the direct-current conversion device, and a control board 20 in other direct-current conversion device. The control board 20 may send a control signal to the normally-on solid-state circuit breaker 10 to turn off the normally-on solid-state circuit breaker 10, thereby removing a fault from an input terminal. The control board 20 may receive feedback signals, such as sampled voltages and/or sampled currents, transmitted from the power modules 30. Control boards 20 in different direct-current conversion devices perform signal interaction with each other to exchange data between the direct-current conversion devices. The data exchanged between different direct-current conversion devices is mainly used for current sharing to ensure the current sharing effect between the direct-current conversion devices. In some embodiments, the control board 20 in the direct-current conversion device performs signal interaction with the control board 20 in other direct-current conversion device via a CAN bus.

In some embodiments, the control board 20 includes a main control chip and multiple diodes.

The main control chip is configured to perform signal interaction with the normally-on solid-state circuit breaker 10 and the power modules 30 in the direct-current conversion device and a control board 20 in other direct-current conversion device.

The diodes are in a one-to-one correspondence with the power modules 30, and are connected in series with a power input terminal of the control board 20. A direct-current power output from the micro power module is input to the control board 20 via a corresponding diode.

In the embodiment, a solution of centralized control on a single main control chip is adopted, ensuring a low delay and fast dynamic response, and rapidly achieving input voltage sharing and output current sharing. The main control chip may be a DSP (Digital Signal Processing) chip.

Referring to FIG. 2, a direct-current power output from each micro power module is input to the control board 20 via a corresponding diode. Thus, multiple power supplies are independent of each other, ensuring power supply reliability.

In some embodiments, auxiliary power supplies for the control board 20 in the direct-current conversion device and auxiliary power supplies for a control board 20 in other direct-current conversion device are connected to an auxiliary bus.

In the embodiment, auxiliary power supplies for the control board 20 in the direct-current conversion device and auxiliary power supplies for a control board 20 in other direct-current conversion device are connected to an auxiliary bus, thereby ensuring power supply reliability for all control boards.

In some embodiments, the control board 20 is further configured to receive a system instruction and upload data.

The control board 20 in each direct-current conversion device may receive the system instruction issued via an Ethernet switch and upload data via the Ethernet switch, to implement remote data interaction and control.

In some embodiments, the power modules 30 in the direct-current conversion device are arranged in two layers. The power module 30 in an upper layer is arranged on a cover plate, and the power module 30 in a lower layer is arranged on a bottom of a housing. The control board 20 is arranged in an intermediate layer. The power module 30 in the upper layer is fixed to the cover plate via bolts, and the power module 30 in the lower layer is fixed to the housing via bolts.

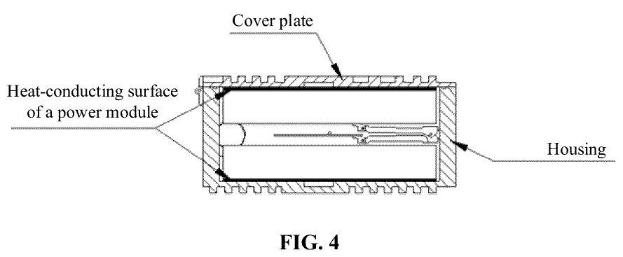

Referring to FIG. 4, the direct-current conversion device is in a sandwiched structure according to the embodiment. The power modules 30 are arranged in two layers. The power module 30 in the upper layer is arranged on the cover plate, and is rotatable along with the cover plate via a semi-open hinge. The power module 30 in the lower layer is arranged on the bottom of the housing. The power module 30 in the upper layer is fixed to the cover plate via bolts, and the power module 30 in the lower layer is fixed to the housing via bolts. The control board 20 is arranged on the intermediate layer. In this way, the power modules 30 are effectively cooled by utilizing the housing, ensuring the heat dissipation effect, and shortening interconnection cables between the control board 20 and the power modules 30.

In summary, the direct-current conversion device in the present disclosure is provided with a normally-on solid-state circuit breaker. A high-voltage direct-current power is transmitted to power modules before the control board is started. The power modules perform power conversion on the input high-voltage direct-current power to obtain a low-voltage direct-current power and supply power to the control board, thereby achieving black start. Thus, a pre-charging circuit is no longer required, effectively reducing the cost and design difficulty. Furthermore, the power modules operate in redundancy mode to supply power to the control board, improving the reliability of the control board. The structure in which input terminals of the power modules are connected in series and output terminals of the power modules are connected in parallel inherently features voltage sharing and current sharing, and implements voltage sharing and current sharing in conjunction with software control. Thus, power supply stability is improved. The control board may turn off the normally-on solid-state circuit breaker to remove a fault, achieving fault protection and removal.

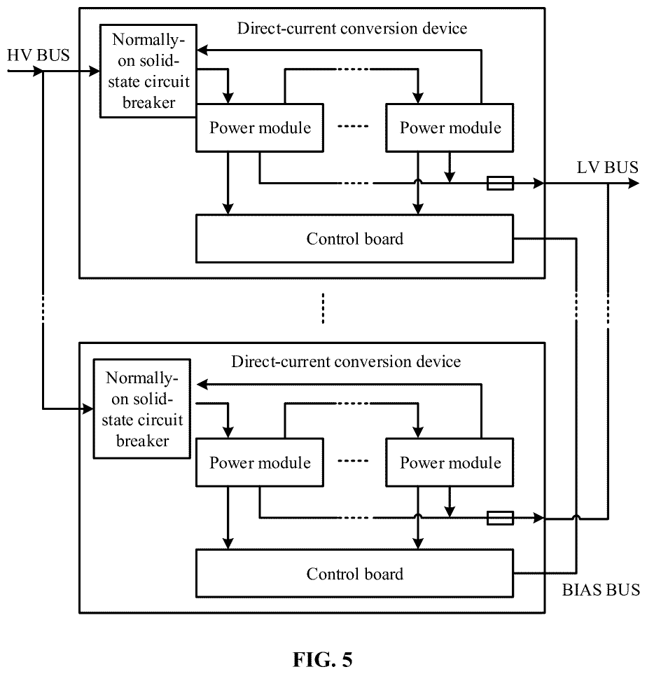

Reference is made to FIG. 5, which is a schematic diagram of a direct-current conversion system according to an embodiment of the present disclosure. Referring to FIG. 5, the direct-current conversion system includes multiple direct-current conversion devices. Output terminals of the direct-current conversion devices are connected in parallel. Each of the direct-current conversion devices includes a normally-on solid-state circuit breaker, a control board and multiple power modules. A direct-current power is input to the direct-current conversion device via the normally-on solid-state circuit breaker. Input terminals of the power modules are connected in series, and output terminals of the power modules are connected in parallel. Each of the power modules is configured to perform power conversion on the input direct-current power and supply power to the control board. The control board is configured to receive voltage signals and/or current signals fed back by the power modules, control the power modules, control the normally-on solid-state circuit breaker, and perform signal interaction with a control board in other direct-current conversion device, achieving current sharing between the multiple direct-current conversion devices.

A high-voltage bus is connected to an input terminal of each of the direct-current conversion devices, and a high-voltage direct-current power is input to the power modules via the normally-on solid-state circuit breaker. Input terminals of the power modules are connected in series, and output terminals of the power modules are connected in parallel. In an aspect, each of the power modules performs power conversion on the input high-voltage direct-current power to output a low-voltage direct-current power to a low-voltage bus for power supply. The low-voltage direct-current power is supplied to a load arranged outside the direct-current conversion device. In another aspect, the power modules perform auxiliary power supply on the control board in the direct-current conversion device. In each direct-current conversion device, a quantity n of the power modules is determined based on a maximum value Vinmax of the input high-voltage direct-current power and a maximum operating voltage Vnmax of each of the power modules. n, Vinmax and Vnmax satisfy n>Vinmax/Vnmax. A quantity m of the direct-current conversion devices is determined based on a total power Ps required by the system and a rated power Pn of a single direct-current conversion device. m, Ps, and Pn satisfy m>Ps/Pn.

In an implementation, each of the power modules includes: a main power conversion circuit, an auxiliary power supply and a micro power module.

The main power conversion circuit is configured to perform power conversion on the input direct-current power.

The auxiliary power supply is configured to supply power to the control board via the micro power module.

The main power conversion circuit is configured to perform power conversion on an input high-voltage direct-current power to obtain a low-voltage direct-current power for power supply. The main power conversion circuit includes a rectifier circuit, a transformer, a filter and the like. The auxiliary power supply and the micro power module are configured to perform auxiliary power supply. Each of the power modules is provided with an independent auxiliary power supply. An input high-voltage direct-current power is regulated to a stable voltage level via the auxiliary power supply, and then the stable voltage level is supplied to the control board via the micro power module. The auxiliary power supply is further configured to supply power to a driver and a control circuit for power transistors on a primary side of the transformer in the power module. Through high-isolation driving and high-isolation sampling, real-time control and monitoring on the main power conversion circuit, active voltage sharing on the primary side and current sharing between the power modules can be achieved.

In an implementation, each of the power modules further includes a voltage dividing capacitor. The voltage dividing capacitor is configured to perform voltage division on the input direct-current power.

In the embodiment, a voltage of the input high-voltage direct-current power is divided by the voltage dividing capacitor, and then is subjected to power conversion to obtain a low-voltage direct-current power. The voltage of the input high-voltage direct-current power is divided by the voltage dividing capacitor and is regulated to a stable voltage level via the auxiliary power supply, and then the stable voltage level is supplied to the control board via the micro power module. The auxiliary power supply may be implemented by a low-voltage auxiliary power supply. Thus, no high-voltage auxiliary power supply is required, simplifying design of the auxiliary power supply.

In an implementation, each of the power modules further includes a decoupling diode.

An anode of the decoupling diode is connected to an output terminal of the power module, and cathodes of decoupling diodes in the power modules are connected to each other.

Each of the power modules is provided with a decoupling diode. An anode of the decoupling diode is connected to the output terminal of the power module, and cathodes of decoupling diodes in the power modules in a same direct-current conversion device are connected to each other. That is, the output terminal of each of the power modules is connected in series with a decoupling diode to form a branch and all such branches are connected in parallel, to prevent current backflow.

The control board performs signal interaction with the normally-on solid-state circuit breaker and power modules in a same direct-current conversion device, and a control board in other direct-current conversion device. The control board may send a control signal to the normally-on solid-state circuit breaker to turn off the normally-on solid-state circuit breaker, thereby removing a fault from an input terminal. The control board may receive feedback signals, such as sampled voltages and/or sampled currents, transmitted from the power modules. Control boards in different direct-current conversion devices perform signal interaction with each other to exchange data between the direct-current conversion devices. The data exchanged between different direct-current conversion devices is mainly used for current sharing to ensure the current sharing effect between the direct-current conversion devices. In some embodiments, the control board in the direct-current conversion device performs signal interaction with control boards in other direct-current conversion device via a CAN bus.

In an implementation, the control board includes a main control chip and multiple diodes.

The main control chip is configured to perform signal interaction with the normally-on solid-state circuit breaker and the power modules in the direct-current conversion device and a control board in other direct-current conversion device.

The diodes are in a one-to-one correspondence with the power modules, and are connected in series with a power input terminal of the control board. A direct-current power output from the micro power module is input to the control board via a corresponding diode.

In the embodiment, a solution of centralized control on a single main control chip is adopted, ensuring a low delay and fast dynamic response, and rapidly achieving input voltage sharing and output current sharing. The main control chip may be a DSP (Digital Signal Processing) chip.

A direct-current power output from each micro power module is input to the control board via a corresponding diode. Thus, multiple power supplies are independent of each other, ensuring power supply reliability.

In an implementation, auxiliary power supplies for the control board and auxiliary power supplies for a control board in other direct-current conversion device are connected to an auxiliary bus.

As shown in FIG. 5, auxiliary power supplies for a control board in a direct-current conversion device and auxiliary power supplies for a control board in other direct-current conversion device are connected to an auxiliary bus (BIAS BUS), ensuring power supply reliability of all control boards.

In an implementation, the control board is further configured to receive a system instruction and upload data.

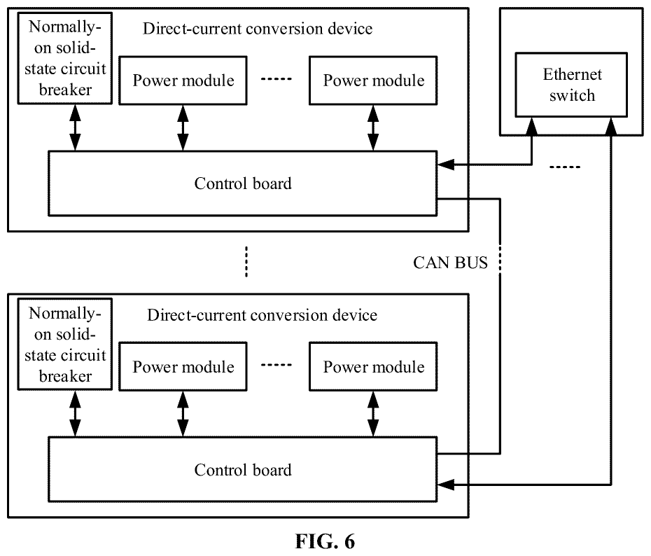

Referring to FIG. 6, the control board in each direct-current conversion device may receive the system instruction issued via an Ethernet switch and upload data via the Ethernet switch, to implement remote data interaction and control.

In an implementation, the power modules in the direct-current conversion device are arranged in two layers. The power module in an upper layer is arranged on a cover plate, and the power module in a lower layer is arranged on a bottom of a housing. The control board is arranged in an intermediate layer. The power module in the upper layer is fixed to the cover plate via bolts, and the power module in the lower layer is fixed to the housing via bolts.

In the embodiment, the direct-current conversion device is in a sandwiched structure. The power modules are arranged in two layers. The power module in an upper layer is arranged on a cover plat, and is rotatable along with the cover plate via a semi-open hinge. The power module in the lower layer is arranged on the bottom of the housing. The power module in the upper layer is fixed to the cover plate via bolts, and the power module in the lower layer is fixed to the housing via bolts. The control board is arranged on the intermediate layer. In this way, the power modules are effectively cooled by utilizing the housing, ensuring the heat dissipation effect, and shortening interconnection cables between the control board and the power modules.

In an implementation, the output terminals of the direct-current conversion devices are connected in series with respective fuses to form branches and all the branches are connected in parallel. That is, a fuse is arranged on an output bus of all power modules in each of the direct-current conversion devices, and the output terminal of the direct-current conversion device is connected to a low-voltage bus via the fuse. Connecting the direct-current conversion device in series with the fuse effectively ensures the safety of power supply.

The direct-current conversion system according to the present disclosure includes multiple direct-current conversion devices. Output terminals of the direct-current conversion devices are connected in parallel. Each of the direct-current conversion devices includes a normally-on solid-state circuit breaker. A high-voltage direct-current power is transmitted to power modules before a control board is started. The power modules perform power conversion on the input high-voltage direct-current power to obtain a low-voltage direct-current power and supply power to the control board, thereby enabling black start. Thus, a pre-charging circuit is no longer required, greatly reducing the cost and design difficulty. Furthermore, the power modules operate in redundancy mode to supply power to the control board, improving the reliability of the control board. The structure in which input terminals of the power modules are connected in series and output terminals of the power modules are connected in parallel inherently features voltage and current sharing, and implements voltage sharing and current sharing in conjunction with software control. Thus, power supply stability is improved. The control board may turn off the normally-on solid-state circuit breaker to remove a fault, achieving fault protection and removal.

Because of the complexity, it is impossible to enumerate all of the embodiments. Those skilled in the art should understand that multiple embodiments may be obtained based on the embodiments in the present disclosure without any creative work. These embodiments fall within the scope of the present disclosure.

The embodiments in the specification are described in a progressive manner. Each of the embodiments mainly focuses on differences from other embodiments, and references can be made to each other for the same or similar parts among the embodiments.

The direct-current conversion device and system according to the present disclosure are described in detail above. The principle and the implementations of the present disclosure are illustrated herein by specific examples. The above description of examples is only intended to facilitate understanding of the method and the idea of the present disclosure. It should be noted that, those skilled in the art may make several improvements and modifications to the present disclosure without departing from the principles of the present disclosure. These improvements and modifications shall fall within the protection scope of the claims of the present disclosure.

It should also be noted that in the present disclosure, relational terms such as first and second are only used to distinguish one entity or operation from another entity or operation. It is not necessarily required or implied that any such actual relationship or order exists among the entities or the operations. Furthermore, the terms such as “include”, “comprise” or any other variants thereof means to be non-exclusive. Therefore, a process, a method, an article, or a device including a series of elements include not only the disclosed elements but also other elements that are not clearly enumerated, or further include inherent elements of the process, the method, the article, or the device. Unless expressively limited, the statement “comprising/including a(n) . . . ” does not exclude the case that other similar elements may exist in such process, method, article or device other than enumerated elements.

1. A direct-current conversion device, comprising:
a normally-on solid-state circuit breaker;
a control board; and
a plurality of power modules, wherein
a direct-current power is input to the direct-current conversion device via the normally-on solid-state circuit breaker;
input terminals of the plurality of power modules are connected in series, and output terminals of the plurality of power modules are connected in parallel;
each of the plurality of power modules is configured to perform power conversion on the input direct-current power, and supply power to the control board; and
the control board is configured to receive at least one of voltage signals and current signals fed back by the plurality of power modules, control the plurality of power modules, control the normally-on solid-state circuit breaker, and perform signal interaction with a control board in other direct-current conversion device, wherein current sharing is achieved between the direct-current conversion device and other direct-current conversion device.

2. The direct-current conversion device according to claim 1, wherein each of the plurality of power modules comprises a main power conversion circuit, an auxiliary power supply and a micro power module, wherein
the main power conversion circuit is configured to perform power conversion on the input direct-current power; and
the auxiliary power supply is configured to supply power to the control board via the micro power module.

3. The direct-current conversion device according to claim 2, wherein each of the plurality of power modules further comprises:
a voltage dividing capacitor, configured to perform voltage division on the input direct-current power.

4. The direct-current conversion device according to claim 3, wherein the plurality of power modules further comprises respective decoupling diodes, wherein
an anode of each of the respective decoupling diodes is connected to an output terminal of the power module; and
cathodes of the respective decoupling diodes in the plurality of power modules are connected to each other.

5. The direct-current conversion device according to claim 2, wherein the control board comprises:
a main control chip, configured to perform signal interaction with the normally-on solid-state circuit breaker, the plurality of power modules and a control board in other direct-current conversion device; and
a plurality of diodes are in a one-to-one correspondence with the plurality of power modules, wherein the plurality of diodes are connected in series with a power input terminal of the control board, and a direct-current power output from the micro power module is input to the control board via the diode corresponding to the micro power module.

6. The direct-current conversion device according to claim 1, wherein auxiliary power supplies for the control board and auxiliary power supplies for a control board in other direct-current conversion device are connected to an auxiliary bus.

7. The direct-current conversion device according to claim 1, wherein the control board performs signal interaction with a control board in other direct-current conversion device via a CAN bus.

8. The direct-current conversion device according to claim 1, wherein the control board is further configured to receive a system instruction and upload data.

9. The direct-current conversion device according to claim 1, wherein
the plurality of power modules in the direct-current conversion device are arranged in two layers, the power module in an upper layer is arranged on a cover plate, and the power module in an lower layer is arranged on a bottom of a housing; and
the control board is arranged in an intermediate layer.

10. The direct-current conversion device according to claim 9, wherein the power module in the upper layer is fixed to the cover plate via bolts, and the power module in the lower layer is fixed to the housing via bolts.

11. A direct-current conversion system, comprising a plurality of direct-current conversion devices according to claim 1, wherein output terminals of the plurality of direct-current conversion devices are connected in parallel.

12. The direct-current conversion system according to claim 11, wherein the output terminals of the plurality of direct-current conversion devices are connected in series with respective fuses to form branches, and the branches are connected in parallel.
